(19) United States
(12) Patent Application Publication
(10) Pub. No.: US 2024/0354528 A1
(43) Pub. Date: Oct. 24, 2024

(54) COMPUTER IMPLEMENTED SYSTEM AND METHOD FOR ENCODING AND DECODING COLOR-CODED FIDUCIAL MARKERS

(71) Applicant: ATAI LABS PRIVATE LIMITED, Hyderabad, Telangana (IN)

(72) Inventors: SIDDARTHA PENDYALA, Karimnagar (IN); KRISHNA KISHORE ANDHAVARAPU, Hyderabad (IN); SATISH CHANDRA GUNDA, Kurnool (IN); KISHOR ARUMILLI, Hyderabad (IN); GANGADHAR GUDE, Hyderabad (IN)

(21) Appl. No.: 18/719,278

(22) PCT Filed: Nov. 30, 2022
(86) PCT No.: PCT/IB2022/061563

§ 371 Date: Jun. 13, 2024

(30) Foreign Application Priority Data
Dec. 10, 2021 (IN) 202141057560

(51) Int. Cl. G06K 7/12; G06K 7/10; G06T 7/20; G06T 7/73; G06T 7/90

(52) U.S. Cl. CPC G06K 7/12; G06K 7/10722; G06T 7/20; G06T 7/73; G06T 7/90; G06T 2207/10024; G06T 2207/30208

(57) ABSTRACT

Exemplary embodiments of the present disclosure are directed towards system for encoding and decoding color-coded fiducial markers, comprising fiducial marker-encoding module configured to encode digits using color-coded fiducial markers and generates color-coded fiducial markers. Color-coded fiducial markers embedded on imaging subject, camera configured to identify motion of imaging subject and captures imaging subject. Camera configured to transmit image frames to first computing device and second computing device over network. Fiducial marker-decoding module configured to receive image frames from camera. Fiducial marker detection module configured to detect presence and location information along with color-coded fiducial markers information from image frames of color-coded fiducial markers using visual object detection technique and machine vision technique. Fiducial marker recognition module configured to detect color-coded fiducial markers from image frames and to recognize sub-makers positioned in color-coded fiducial markers. Digit-generating module configured to decode digits and forms number from sub-makers positioned in color-coded fiducial markers.

### TECHNICAL FIELD

The disclosed subject matter relates generally to fiducial marker detection technology. More particularly, the present disclosure relates to a computer-implemented system and method for encoding and decoding color-coded fiducial markers.

### BACKGROUND

Modern inventory systems, such as warehouses, supply chain distribution centers, airport luggage systems, and custom-order manufacturing facilities, face significant challenges in responding to requests for inventory items. As inventory systems grow, the challenges of simultaneously completing a large number of packings, storing, and other inventory-related tasks become non-trivial. Manufacturing industries like food, fat, beverage, and pharmaceuticals ensure to label the manufacturing date of a product. Cardboard is often the material of choice that is utilized across a wide range of manufacturing industries for packing inventory items or the produced goods.

The warehouse is a physical environment in manufacturing industry, where the inventory items or the produced goods in the packaged form (one or more individual packages in cardboard) are stored and dispatched to the customer on a need basis. In the warehouse, the packages are moved from one location to another during the storage process. For example, in manufacturing industry, the finished products are packed inside boxed cargo and cans for further storing in warehouses. The products are also transported from one warehouse to another by using trucks and other vehicles. During the process of storing and transporting, it is required to know the manufacturing date of the finished product for easy tracking and digitization.

The color-coded marker patterns are mounted on the inventory items, objects, or scenes to allow automatic systems for finding the correspondence between points in the world and points in camera images, and for finding the correspondences between points in one camera image and points in another camera image. The cameras are installed at various locations inside the warehouse to detect and decode the manufacturing date on the cardboard, which is a camera friendly color-coded fiducial marker. The conventional optical character-based detection and recognition systems fail to detect and recognize the color-coded fiducial markers in real-time from a moving wagon.

In the light of the aforementioned discussion, there exists a need for a system for encoding and decoding color-coded fiducial markers.

### SUMMARY

The following presents a simplified summary of the disclosure in order to provide a basic understanding of the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

An objective of the present disclosure is directed towards a system and method for encoding and decoding digits color-coded fiducial markers.

Another objective of the present disclosure is directed towards using the color-coded fiducial markers to encode the wagon numbers and enabling to detect the wagon numbers using computer vision technology.

Another objective of the present disclosure is directed towards detecting and recognizing the color-coded fiducial markers in real-time from a moving boxed cargo with an accuracy and encoding the manufacturing date on the boxed cargo.

Another objective of the present disclosure is directed towards the color-coded fiducial markers are very robust.

Another objective of the present disclosure is directed towards detecting the color-coded fiducial markers in various scenarios such as motion blur, occlusion, and low lighting conditions.

Another objective of the present disclosure is directed towards identifying individual wagons from a series of continuously moving wagons with the help of color-coded fiducial markers.

Another objective of the present disclosure is directed towards proposing color-coded fiducial marker in the form of a matrix.

In an embodiment of the present disclosure, a fiducial marker-encoding module is configured to encode one or more digits using one or more color-coded fiducial markers and generates the one or more color-coded fiducial markers.

In another embodiment of the present disclosure, the one or more color-coded fiducial markers embedded on an imaging subject placed in the field of view of a camera, the imaging subject comprising at least one of: boxed cargos; wagons; objects; goods; and vehicles.

In another embodiment of the present disclosure, the camera is configured to identify a motion of the imaging subject and configured to capture the imaging subject, the camera configured to transmit the one or more image frames to a first computing device and a second computing device over a network.

In another embodiment of the present disclosure, the first computing device and the second computing device comprising a fiducial marker-decoding module configured to receive one or more image frames from the camera.

In another embodiment of the present disclosure, the fiducial marker-decoding module comprising a fiducial marker detection module, wherein the fiducial marker detection module is configured to detect presence and location information along with color-coded fiducial markers information from the one or more image frames of the one or more color-coded fiducial markers.

In another embodiment of the present disclosure, the fiducial marker detection module is configured to transmit the presence and location information along with the color-coded fiducial markers information to a fiducial marker recognition module.

In another embodiment of the present disclosure, the fiducial marker recognition module is configured to detect the one or more color-coded fiducial markers from the one or more image frames and the one or more detected color-coded fiducial markers are used to recognize one or more sub-makers positioned in the one or more color-coded fiducial markers.

In another embodiment of the present disclosure, the fiducial marker recognition module comprising image processing techniques configured to automatically detect each sub-marker and a color information.

In another embodiment of the present disclosure, a digit-generating module is configured to decode the one or more digits from the one or more sub-makers positioned in the one or more color-coded fiducial markers; and

In another embodiment of the present disclosure, a digit-calculating module is configured to calculate last check digit from the one or more color-coded fiducial markers.

### BRIEF DESCRIPTION OF THE DRAWINGS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

FIG. 1A, FIG. 1B are example diagrams depicting a color-coded fiducial marker, in accordance with one or more exemplary embodiments.

FIG. 1C is an example diagram depicting sub-marker color space values, in accordance with one or more exemplary embodiments.

FIG. 2A is an example diagram depicting the use of two sub-markers as a single digit, in accordance with one or more exemplary embodiments.

FIG. 2B is an example diagram depicting the color-coded fiducial marker representing two digits, in accordance with one or more exemplary embodiments.

FIG. 2C is an example diagram depicting representation of the first ten digits of a wagon number using five color coded fiducial markers, in accordance with one or more exemplary embodiments.

FIG. 2D is an example diagram depicting the first ten digits (3110169521) of a wagon number using five color-coded fiducial markers on an empty wagon, in accordance with one or more exemplary embodiments.

FIG. 2E is an example diagram depicting the two color-coded fiducial markers encoded with 160 and 220, in accordance with one or more exemplary embodiments.

FIG. 2F is an example diagram depicting the encoding of the manufacturing date using two fiducial markers using six digits, in accordance with one or more exemplary embodiments.

FIG. 2G is an example diagram depicting the embedding of manufacturing date using color-coded fiducial markers, in accordance with one or more exemplary embodiments.

FIG. 3 is a block diagram representing a system in which aspects of the present disclosure can be implemented. Specifically, FIG. 3 depicts a schematic representation of the system for encoding and decoding color-coded fiducial markers, in accordance with one or more exemplary embodiments.

FIG. 4 is a block diagram depicting a schematic representation of the fiducial marker-decoding module shown in FIG. 3, in accordance with one or more exemplary embodiments.

FIG. 5 is an example of flow diagram depicting a method for encoding and decoding color-coded fiducial markers, in accordance with one or more exemplary embodiments.

FIG. 6 is another example of flow diagram depicting a method for encoding and decoding color-coded fiducial markers of a boxed cargo, in accordance with one or more exemplary embodiments.

FIG. 7 is another example of flow diagram depicting a method for encoding and decoding color-coded fiducial markers of a wagon, in accordance with one or more exemplary embodiments.

FIG. 8 is a block diagram illustrating the details of digital processing system in which various aspects of the present disclosure are operative by execution of appropriate software instructions.

### DETAILED DESCRIPTION OF EXAMPLE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and the like, herein do not denote any order, quantity, or importance, but rather are used to distinguish one element from another.

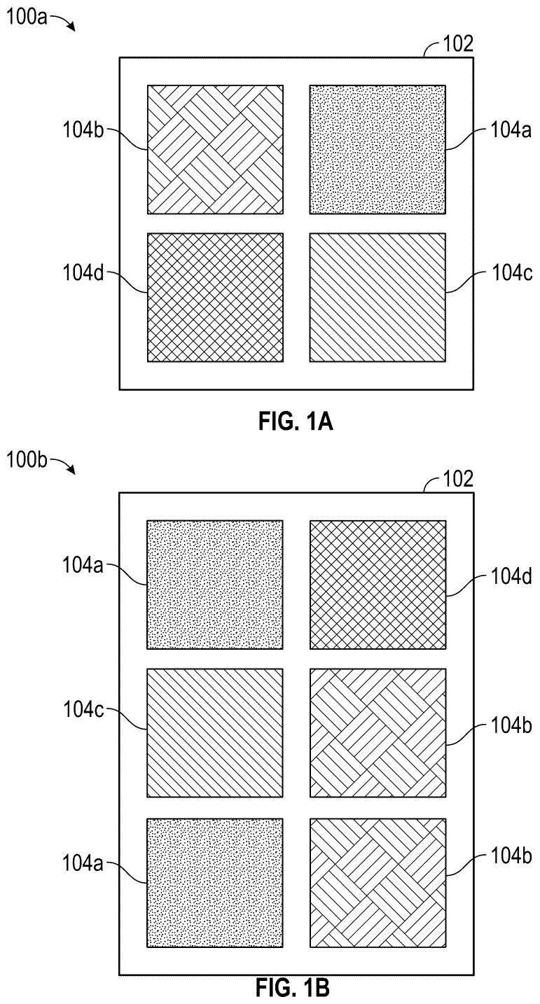

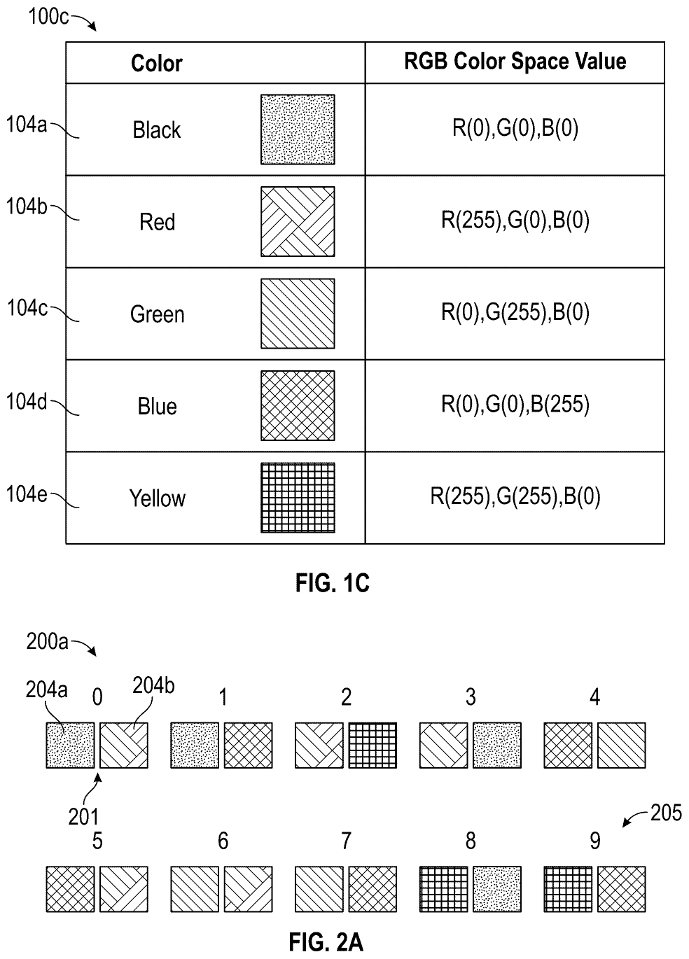

Referring to FIG. 1A, FIG. 1B, FIG. 1A and FIG. 1B are example diagrams 100a and 100b depicting a color-coded fiducial marker, in accordance with one or more exemplary embodiments. The diagrams 100a and 100b include a color-coded fiducial marker 102. The color-coded fiducial marker 102 includes a first sub marker 104a, a second sub marker 104b, a third sub marker 104c, a fourth sub marker 104d, a fifth sub marker 104e (not shown), a sixth sub marker 104f (not shown) and so forth. The color-coded fiducial marker 102 may be printed or attached to an object in the field of view of a camera (an imaging system) which appears in the image frames produced, for use as a point of reference or a measure. The camera may be positioned at multiple locations. The multiple locations may include, but are not limited to, near the truck, inside a warehouse, and so forth. The color-coded fiducial marker 102 may be positioned into or on an imaging subject. The imaging subject may include, but is not limited to, boxed cargo, wagons, objects, goods, vehicles, and so forth. The wagons may include, but are not limited to open wagon, covered wagon, tank wagon, flat wagon, hopper wagon, well wagon, brake van, and so forth.

For example, the color-coded fiducial marker 102 includes six sub-markers in a grid-like fashion. Each color represents a sub-marker, a rectangular-shaped color box. The sub-marker is represented by Sᵢ (For example, where i ranges from 1 to 6). Sᵢ is represented by five colors, which are Red, Black, Blue, Green, and Yellow. The sub-markers may be represented in multiple shapes. The shapes of the sub-markers may include, but are not limited to, a rectangular, a triangular, a circular, and so forth. The color-coded fiducial marker 102 may be configured to encode digits/characters and detects the digits/characters using computer vision technology. The digits/characters may include, but are not limited to, the manufacturing date of a product, wagon number, location, unique identification number, and so forth.

Referring to FIG. 1C, FIG. 1C is an example diagram 100c depicting sub-marker color space values, in accordance with one or more exemplary embodiments. The diagram includes a black color sub-marker 104a, a red color sub-marker 104b, a green color sub-marker 104c, a blue color sub-marker 104d, and a yellow color sub-marker 104e. The sub-marker color space values are represented in the following table:

| Color | RGB color space value |
|---|---|
| Black | R(0), G(0), B(0) |
| Red | R(255), G(0), B(0) |
| Green | R(0), G(255), B(0) |
| Blue | R(0), G(0), B(255) |
| Yellow | R(255), G(255), B(0) |

In an exemplary embodiment, Indian railways follow an 11-digit wagon numbering system, for easy identification and computerization of a wagon's information. The first two digits indicate Type of Wagon, the third and fourth digits indicate Owning Railway, the fifth and sixth digits indicate Year of Manufacture, the seventh through tenth digits indicate Individual Wagon Number and the last digit is a Check digit.

The first two digits of the wagon number which indicates the type of wagon are categorized as different types of wagons. Based on the permissible speed (loaded/empty) and axle load, there are different types of wagons. The below table shows the allotted code for each type of wagon.

The types of wagons and allotted digits are represented in the following table:

| Type of wagon | Allotted range |
|---|---|
| Open wagon | 10 to 29 |
| Covered wagon | 30 to 39 |
| Tank wagon | 40 to 54 |
| Flat wagon | 53 to 69 |
| Hopper wagon | 70 to 79 |
| Well Wagon | 80 to 84 |
| Brake Van | 85 to 89 |

The third and fourth digits indicate the owning railway. The following table shows the allotted code for the corresponding railway zone.

The Owning railway and allotted digits are represented in the following table:

| Code | |
|---|---|
| allotted | Owning railway |
| 01 | Central Railway Zone |
| 02 | Eastern Railway Zone |
| 03 | Northern Railway Zone |
| 04 | North Eastern |
| | Railway Zone |
| 05 | Northeast Frontier |
| | Railway Zone |
| 06 | Southern Railway Zone |
| 07 | South Eastern Railway Zone |
| 08 | Western Railway Zone |
| 09 | South Central |
| | Railway Zone |
| 10 | East Central Railway Zone |
| 11 | North Western Railway |
| | Zone |
| 12 | East Coast Railway Zone |
| 13 | North Central Railway |
| | Zone |
| 14 | South East Central Railway |
| | Zone |
| 15 | South Western Railway |
| | Zone |
| 16 | West Central Railway Zone |
| 24 | Wagons owned by Defence |
| 25 | Wagons owned by |
| | CONCOR |
| 26 | Wagons owned by other |
| | private parties |

The fifth and sixth digits indicate the year of manufacture. For example, 04 for 2004, 18 for 2018. The seventh to tenth digit indicates individual wagon number, a running serial number from 0001 to 9999. Numbers from 0001 to 0999 are departmental stock, 1000 to 9999 are for other traffics stock. The last digit is a check digit. The check digit for each wagon may be calculated using a six-step method as indicated below. Let the wagon number be C1 C2 C3 C4 C5 C6 C7 C8 C9 C10 C11. (C1 is the first digit; C2 is the second digit; and so forth).

The method of performing calculation of check digit from first 10 digits, at step 1, starting from the left, adding all the characters in the even position. S1=C2+C4+C6+C8+C10. Thereafter at step 2, multiplying the sum by 3 to get 3×S1. Thereafter at step 3, starting from the left, adding all the characters in the odd position. S2=C1+C3+C5+C7+C9. Thereafter at step 4, adding the sum of step 2 to the sum of step 3 to get S4=3×S1+S2. Thereafter at step 5, round this total up to the next multiple of 10. Thereafter at step 6, the check digit is the number required to the added to round up to the next multiple of 10.

In an exemplary embodiment, the method for calculating the check digit from first ten digits with an example: Let the wagon number is 31101695215. The method commence at step 1, adding all the characters in the even position S1=C2+C4+C6+C8+C10=1+0+6+5+1=13. Thereafter at step 2, Multiplying the sum by 3 to get 3×S1=39. Thereafter at step 3, adding all the characters in the odd position, S2=C1+C3+C5+C7+C9=3+1+1+9+2=16. Thereafter at step 4, adding the sum of step 2 to the sum of step 3 to get S4=3×S1+S2=39+16=55. Thereafter at step 5, Round this total up to the next 10th multiple of 55=60. Thereafter at step 6, Check digit=60−55=5. Hence, the eleventh digit is assigned as 5 for the particular wagon.

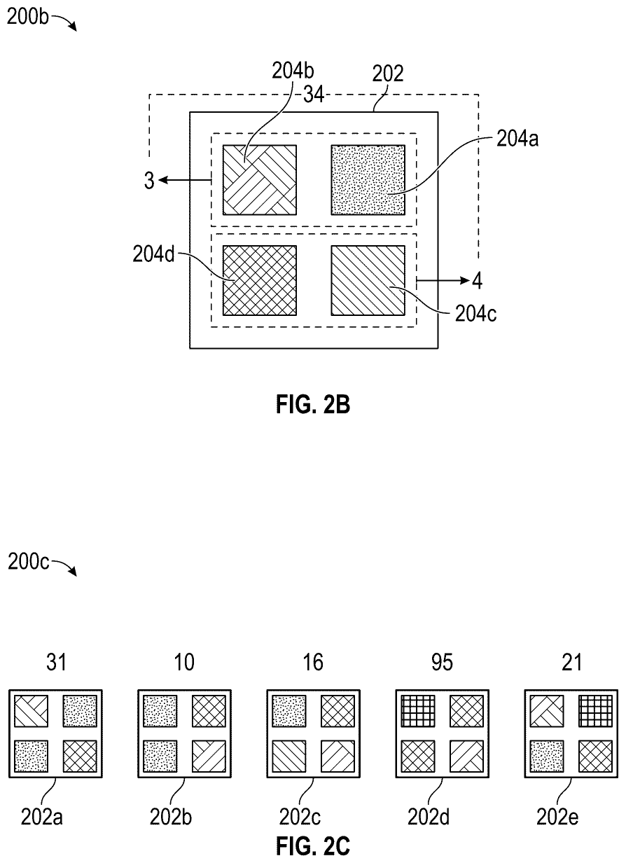

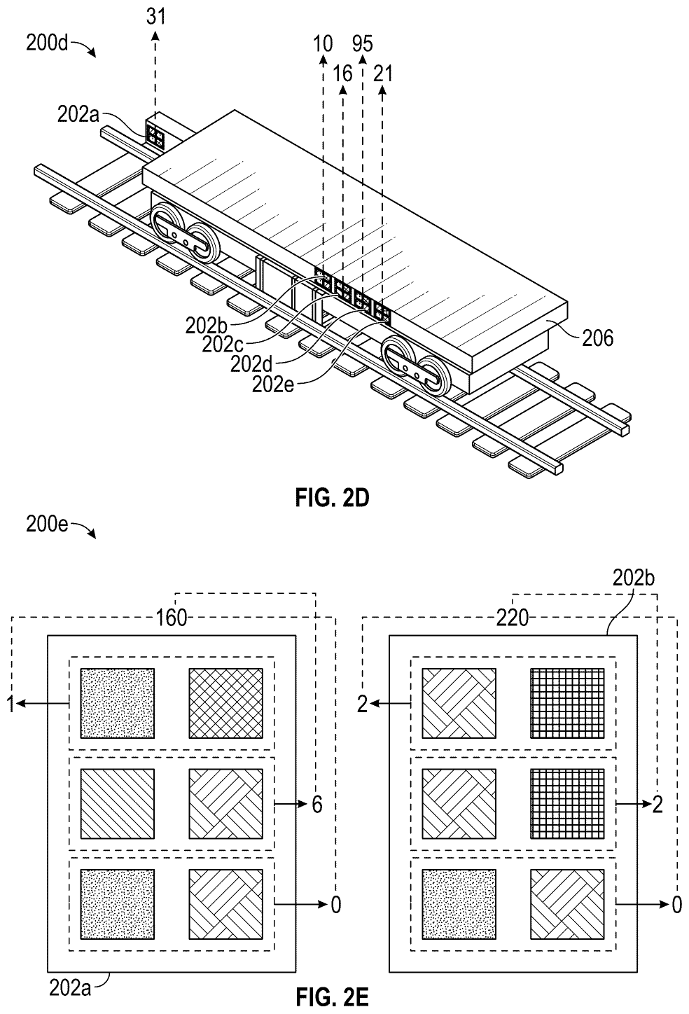

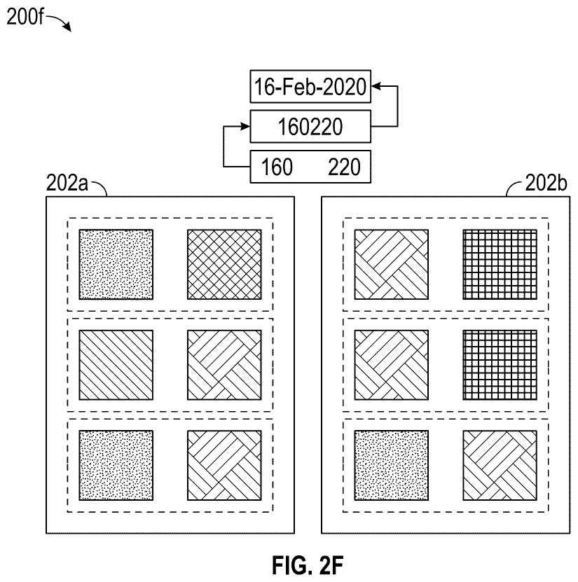

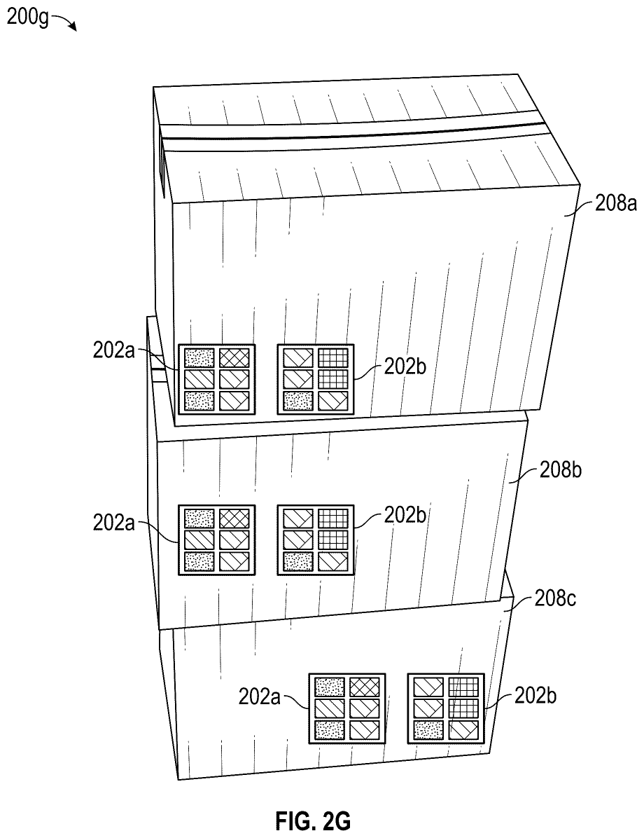

Referring to FIG. 2A, FIG. 2A is an example diagram 200a depicting the use of two sub-markers as a single digit, in accordance with one or more exemplary embodiments. The diagram 200a includes sub markers 201, digits 205. The two sub-markers for example, the first sub-marker 204a, the second sub-marker 204b may represent a single digit. The color value of each sub-marker of a digit is a subset of one of the five colors, which are mentioned in the sub-marker color space values.

Referring to FIG. 2B, FIG. 2B is an example diagram 200b depicting the color-coded fiducial marker representing two digits, in accordance with one or more exemplary embodiments. The diagram 200b includes the color-coded fiducial marker 202. The color-coded fiducial marker 202 includes the first sub-marker 204a, the second sub-marker 204b, the third sub-maker 204c, and the fourth sub-marker 204d. The color-coded fiducial marker 202 may be configured to represent two digits.

Referring to FIG. 2C, FIG. 2C is an example diagram 200c depicting a representation of the first ten digits of a wagon number using five color coded fiducial markers, in accordance with one or more exemplary embodiments. The diagram 200c includes color-coded fiducial markers 202a, 202b, 202c, 202d, and 202e. The diagram 200c representing the encoding of the first ten digits (3110169521) from an eleven-digit wagon number (31101695215) using five color-coded fiducial markers 202a, 202b, 202c, 202d, and 202e.

Referring to FIG. 2D, FIG. 2D is an example diagram 200d depicting the first ten digits (3110169521) of a wagon number using five color-coded fiducial markers on an empty wagon, in accordance with one or more exemplary embodiments. The diagram 200d includes an empty wagon 206, and color-coded fiducial markers 202a, 202b, 202c, 202d, and 202e. The first ten digits of the wagon number using five color-coded fiducial markers 202a, 202b, 202c, 202d, and 202e as shown in FIG. 2C are used to embed on the empty wagon 206.

Referring to FIG. 2E, FIG. 2E is an example diagram 200e depicting the two color-coded fiducial markers encoded with 160 and 220, in accordance with one or more exemplary embodiments. The diagram 200e includes the color-coded fiducial markers 202a, 202b. The manufacturing date on the boxed cargo is represented by using two color-coded fiducial markers 202a, 202b, with each color-coded fiducial marker representing three digits. For example, if the manufacturing date which is to be encoded is 16 Feb. 2020, then day (16) is encoded as 16, month (February) is encoded as 02 and the year (2020) of manufacturing is encoded as 20. The six-digit manufacturing date 160220 is split between two color-coded fiducial markers 202a, 202b. In the first fiducial marker 202a, the number 160 is encoded in the first marker 202a and the number 220 is encoded in the second marker 202b.

Referring to FIG. 2F, FIG. 2F is an example diagram 200f depicting the encoding of the manufacturing date using two fiducial markers using six digits, in accordance with one or more exemplary embodiments. The diagram 200f includes the color-coded fiducial markers 202a, 202b. The color-coded fiducial markers 202a, 202b may be configured to encode the manufacturing date (For example, 16 Feb. 2020) using six digits as 160220. The color-coded fiducial markers 202a, 202b may be embedded on the boxed cargo to represent the manufacturing date of the finished product inside the box.

Referring to FIG. 2G, FIG. 2G is an example diagram 200g depicting the embedding of manufacturing date using color-coded fiducial markers, in accordance with one or more exemplary embodiments. The diagram 200g includes the color-coded fiducial markers 202a, 202b, and the boxed cargos 208a, 208b and 208c. The color-coded fiducial markers 202a, 202b may be positioned on the boxed cargos 208a, 208b and 208c.

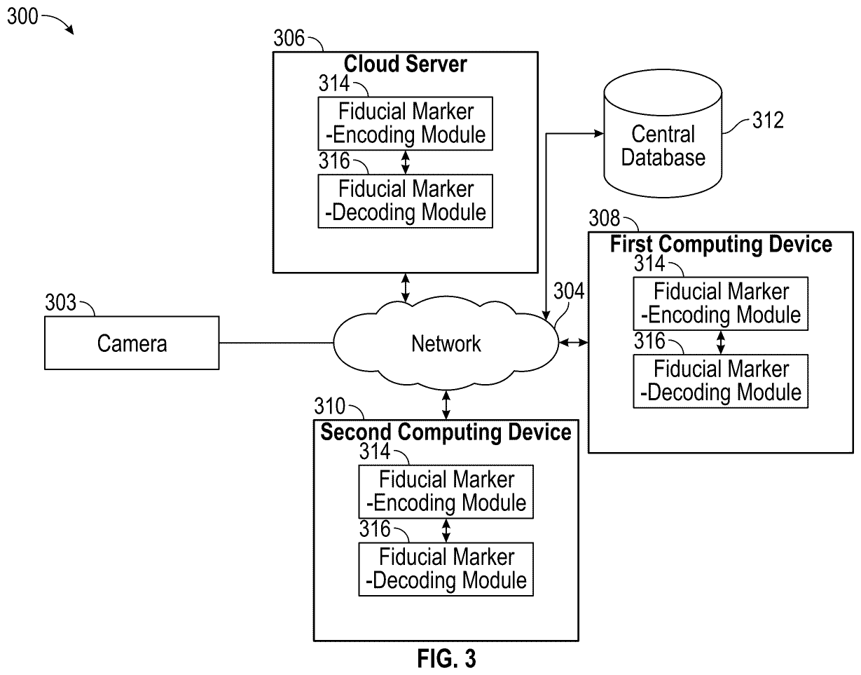

Referring to FIG. 3, FIG. 3 is a block diagram 300 representing a system in which aspects of the present disclosure can be implemented. Specifically, FIG. 3 depicts a schematic representation of the system for encoding and decoding color-coded fiducial markers, in accordance with one or more exemplary embodiments. The system 300 includes camera 303, a network 304, a cloud server 306, a first computing device 308, a second computing device 310, and a central database 312. The first computing device 308, the second computing device 310 and the central database 312 may include a fiducial marker-encoding module 314, and a fiducial marker-decoding module 316.

A first user may operate the first computing device 308. The first user may include, but is not limited to, a manager, a supervisor, an administrator, a director, and so forth. The second computing device 310 may be located in a backroom at a server location. The server location may include one or more programmed computers and are in wired, wireless, direct, or networked communication (the network 304) with the camera 303.

The network 304 may include, but is not limited to, an Ethernet, a wireless local area network (WLAN), or a wide area network (WAN), a Bluetooth low energy network, a ZigBee network, a Controller Area Network (CAN bus), a WIFI communication network e.g., the wireless high speed internet, or a combination of networks, a cellular service such as a 4G (e.g., LTE, mobile WiMAX) or 5G cellular data service, a RFID module, a NFC module, wired cables, such as the world-wide-web based Internet, or other types of networks may include Transport Control Protocol/Internet Protocol (TCP/IP) or device addresses (e.g. network-based MAC addresses, or those provided in a proprietary networking protocol, such as Modbus TCP, or by using appropriate data feeds to obtain data from various web services, including retrieving XML data from an HTTP address, then traversing the XML for a particular node) and the like without limiting the scope of the present disclosure.

Although the first and second computing devices 308, 310 are shown in FIG. 3, an embodiment of the system 300 may support any number of computing devices. The system 300 may support only one computing device (308 or 310). The computing devices 308, 310 may include, but are not limited to, a desktop computer, a personal mobile computing device such as a tablet computer, a laptop computer, or a netbook computer, a smartphone, a server, an augmented reality device, a virtual reality device, a digital media player, a piece of home entertainment equipment, backend servers hosting database 312 and other software, and the like. Each computing device 308, 310 supported by the system 300 is realized as a computer-implemented or computer-based device having the hardware or firmware, software, and/or processing logic needed to carry out the intelligent messaging techniques and computer-implemented methodologies described in more detail herein.

The fiducial marker-encoding module 314 and the fiducial marker-decoding module 316 may be downloaded from the cloud server 306. For example, the fiducial marker encoding module 314 and the fiducial marker-decoding module 316 may be any suitable application downloaded from, GOOGLE PLAY® (for Google Android devices), Apple Inc.'s APP STORE® (for Apple devices, or any other suitable database). In some embodiments, the fiducial marker-encoding module 314, and the fiducial marker-decoding module 316 may be software, firmware, or hardware that is integrated into the first computing device 308 and the second computing device 310. The fiducial marker-encoding module 314 and the fiducial marker-decoding module 316 which are accessed as mobile applications, web applications, software that offers the functionality of accessing mobile applications, and viewing/processing of interactive pages, for example, are implemented in the first computing device 308 and the second computing device 310 as will be apparent to one skilled in the relevant arts by reading the disclosure provided herein.

The camera 303 may include, but is not limited to, three-dimensional cameras, thermal image cameras, infrared cameras, night vision cameras, varifocal cameras, and so forth. The camera 303 may be configured to capture the continuous image frames of the boxed cargos, wagons, objects, goods, vehicles, and so forth and transmits to the first computing device 308 and the second computing device 310 over the network 304. The first computing device 308 and the second computing device 310 may be configured to receive the captured image frames of the boxed cargos, wagons, objects, goods, vehicles, and so forth over the network 304. The first computing device 308 and the second computing device 310 includes the fiducial marker-encoding module 314 and the fiducial marker-decoding module 316.

The fiducial marker-encoding module 314 may be configured to encode the digits/characters using the color-coded fiducial marker 102. The digits/characters may include, but are not limited to, a wagon number, a manufacturing date, location information, unique identification code, and so forth. The fiducial marker-encoding module 314 may be configured to encode the digits of at least one of the boxed cargos, the wagons, the objects, the goods, the vehicles using the color-coded fiducial marker 102. The fiducial marker-encoding module 314 may be configured to generate the color-coded fiducial markers. The fiducial marker-decoding module 316 may include a computer vision technology configured to detect the one or more color-coded fiducial markers. The fiducial marker-decoding module 316 may be configured to decode the image frames of the color-coded fiducial marker 102 captured by the camera 303. The central database 312 may be configured to store one or more images of the imaging subject, the color information, the position of the color-coded fiducial marker on the imaging subject, color-codes, and so forth.

In an exemplary embodiment of the present disclosure, the finished goods are stored in a warehouse. The finished goods are moved from a truck to the warehouse in the form of a boxed cargo. During the cargo movement process, the fixed camera 303 positioned near the truck is configured to capture the image frames of continuous movement of the boxed cargo, wagons. The captured image frames of at least one of the boxed cargos, the wagons, the objects, the goods, the vehicles containing the color-coded fiducial markers, and the captured image frames are passed to the fiducial marker-decoding module 316.

In another exemplary embodiment of the present disclosure, the fiducial marker-encoding module 114 may be configured to encode the digits of the wagon number using the color-coded fiducial marker 102 where the wagon number consisting of 11 digits, is encoded using five color-coded fiducial markers. First, 10 digits of the wagon number are only encoded into five color-coded fiducial markers, and the 11th digit is calculated after successful decoding of the first 10 digits of the wagon number. The ten digits of a wagon number are split among five color-coded fiducial markers. Each marker includes two digits of the wagon number. In the current invention two sub-markers, placed adjacent to each other are used to represent a single digit (0, 1, 2, 3, 4, 5, 6, 7, 8, 9) of the decimal number system.

In another exemplary embodiment, the fiducial marker-encoding module 314 may be configured to encode the digits of the manufacturing date of the boxed cargo using the color-coded fiducial marker 102. The manufacturing date, consisting of six digits, is encoded using two color-coded fiducial markers. For example, if the manufacturing date is 16 Feb. 2020 and it is encoded as 160220. Six digits are used for encoding the manufacturing date. The first two digits may indicate the day (01 to 31), the third and fourth digits may indicate the month (01 to 12), the fifth and sixth digits may indicate the year of manufacturing (last two digits of a year, for example, if the year is 2020, then it is 20) as shown in the following table:

| Manufacturing date | | Encoded digits |
|---|---|---|
| Day (01 to 31) | First day of the month | 01 |
| | Fifth day of the month | 05 |
| | Tenth day of the month | 10 |
| | Fifteenth day of the month | 15 |
| | Twenty first day of the month | 21 |
| | Twenty first day of the month | 31 |
| Month (01 to 12) | January | 01 |
| | February | 02 |
| | March | 03 |
| | April | 04 |
| | May | 05 |
| | June | 06 |
| | July | 07 |
| | August | 08 |
| | September | 09 |
| | October | 10 |
| | November | 11 |
| | December | 12 |
| Year(00 to 99) | 2000 | 00 |
| | 2010 | 10 |
| | 2020 | 20 |
| | 2050 | 50 |
| | 2099 | 99 |

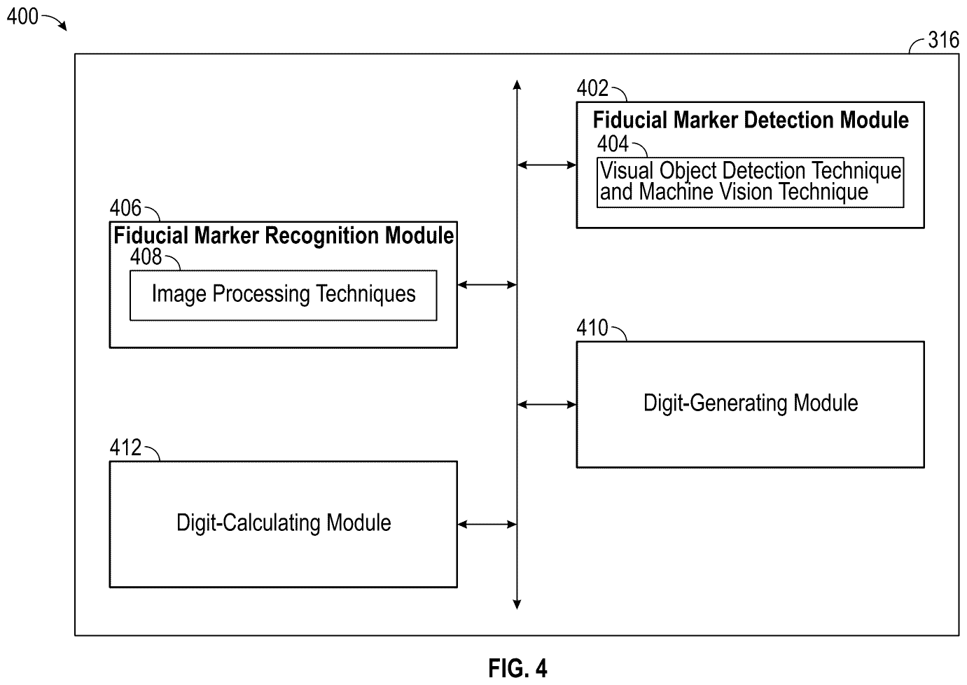

Referring to FIG. 4, FIG. 4 is a block diagram 400 depicting a schematic representation of the fiducial marker-decoding module 316 shown in FIG. 3, in accordance with one or more exemplary embodiments. The diagram 400 includes a bus 401, the fiducial marker-decoding module 316. The fiducial marker-decoding module 316 includes a bus 401, a fiducial marker detection module 402, a visual object detection technique and machine vision technique 404, a fiducial marker recognition module 406, image processing techniques 408, a digit-generating module 410, a digit-calculating module 412.

The fiducial marker-encoding module 314 may be configured to encode the digits using the color-coded fiducial markers and generates the color-coded fiducial markers. The color-coded fiducial markers may be embedded on at least one of the boxed cargos; the wagons; the objects; the goods; and the vehicles are used for the detection and recognition. The camera 303 may be configured to identify the movements and captures at least one of the boxed cargos; the wagons; the objects; the goods; and vehicles. The camera 303 may be configured to transmit the captured image frames to the first computing device 308 and the second computing device 310 over the network 304, the image frames comprising the images of the color-coded fiducial markers.

The fiducial marker-decoding module 316 may be configured to receive image frames from the camera 303. The fiducial marker-decoding module 316 includes a fiducial marker detection module 402. The fiducial marker detection module 402 may be configured to detect the presence and location information along with color-coded fiducial markers information from the image frames (localization) of the color-coded fiducial markers using a visual object detection technique and machine vision technique 404. The fiducial marker detection module 402 may be configured to transmit the presence and location information along with the color-coded fiducial markers information to the fiducial marker recognition module 406. The color-coded fiducial marker information includes the position of the color-coded fiducial marker on the imaging subject, and so forth.

The fiducial marker recognition module 406 may be configured to detect the color-coded fiducial markers from the image frames and the detected color-coded fiducial markers are used to recognize the sub-makers positioned in the color-coded fiducial markers. The fiducial marker recognition module 406 includes image processing techniques 408 configured to automatically detect each sub-marker and a color information. After detecting all the sub-markers along with the recognition of color information, the digit-generating module 410 may be configured to decode the digits and form a number from the sub-makers positioned in the color-coded fiducial markers. The digit-calculating module 412 may be configured to calculate a last check digit from the color-coded fiducial markers.

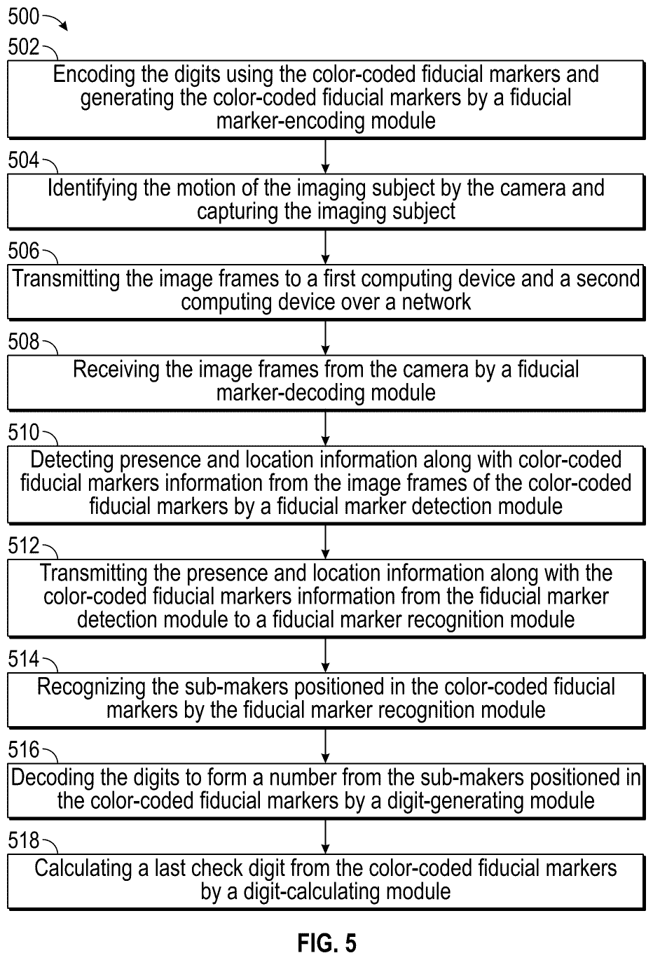

Referring to FIG. 5, FIG. 5 is an example of flow diagram 500 depicting a method for encoding and decoding color-coded fiducial markers, in accordance with one or more exemplary embodiments. The method 500 may be carried out in the context of the details of FIG. 1, FIG. 2A, FIG. 2B, FIG. 2C, FIG. 2D, FIG. 3A, FIG. 3B, FIG. 3C, FIG. 4A and FIG. 4B. However, the method 500 may also be carried out in any desired environment. Further, the aforementioned definitions may equally apply to the description below.

The method commences at step 502, encoding the digits using the color-coded fiducial markers and generating the color-coded fiducial markers by a fiducial marker-encoding module, the one or more color-coded fiducial markers embedded on an imaging subject in a field view of a camera. Thereafter at step 504, identifying the motion of the imaging subject by the camera and capturing the imaging subject. Thereafter at step 506, transmitting the image frames to a first computing device and a second computing device over a network, the one or more image frames comprising one or more images of the color-coded fiducial markers. Thereafter at step 508, receiving the image frames from the camera by a fiducial marker-decoding module. Thereafter at step 510, detecting presence and location information along with color-coded fiducial markers information from the one or more image frames of the one or more color-coded fiducial markers by a fiducial marker detection module. Thereafter at step 512, transmitting the presence and location information along with the color-coded fiducial markers information from the fiducial marker detection module to a fiducial marker recognition module. Thereafter at step 514, recognizing the sub-makers positioned in the color-coded fiducial markers by the fiducial marker recognition module. Thereafter at step 516, decoding the digits to form a number from the sub-makers positioned in the color-coded fiducial markers by a digit-generating module. Thereafter at step 518, calculating a last check digit from the color-coded fiducial markers by a digit-calculating module.

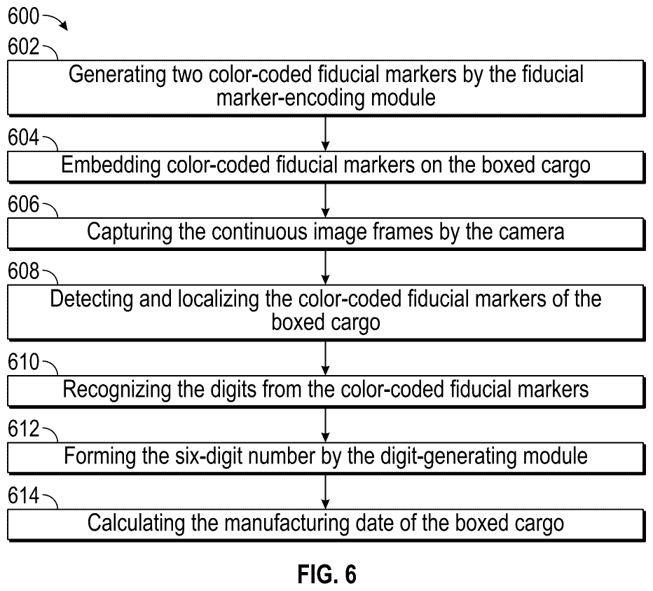

Referring to FIG. 6, FIG. 6 is another example of flow diagram 600 depicting a method for encoding and decoding color-coded fiducial markers of a boxed cargo, in accordance with one or more exemplary embodiments. The method 600 may be carried out in the context of the details of FIG. 1, FIG. 2A, FIG. 2B, FIG. 2C, FIG. 2D, FIG. 3A, FIG. 3B, FIG. 3C, FIG. 4A FIG. 4B, and FIG. 5. However, the method 600 may also be carried out in any desired environment. Further, the aforementioned definitions may equally apply to the description below.

The method commences at step 602, generating two color-coded fiducial markers by the fiducial marker-encoding module. Thereafter at step 604, embedding color-coded fiducial markers on the boxed cargo. Thereafter at step 606, capturing the continuous image frames by the camera. Thereafter at step 608, detecting and localizing the color-coded fiducial markers of the boxed cargo. Thereafter at step 610, recognizing the digits from the color-coded fiducial markers. Thereafter at step 612, forming the six-digit number by the digit-generating module. Thereafter at step 614, calculating the manufacturing date of the boxed cargo.

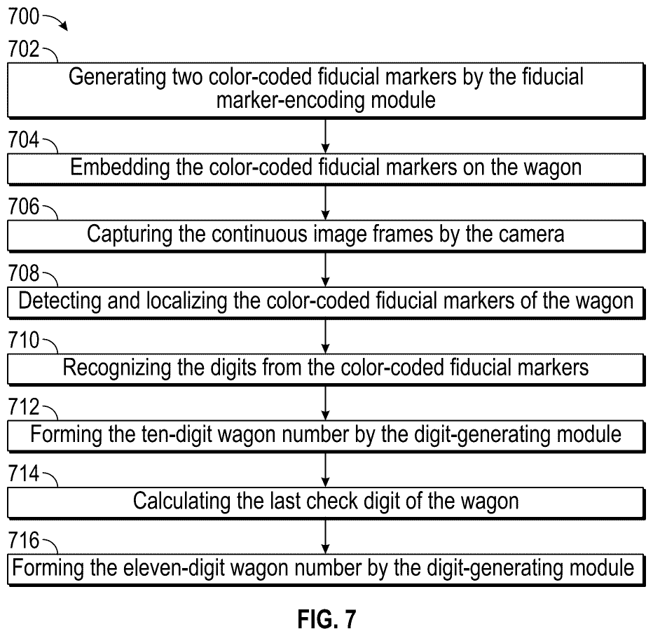

Referring to FIG. 7, FIG. 7 is another example of flow diagram 700 depicting a method for encoding and decoding color-coded fiducial markers of a wagon, in accordance with one or more exemplary embodiments. The method 700 may be carried out in the context of the details of FIG. 1, FIG. 2A, FIG. 2B, FIG. 2C, FIG. 2D, FIG. 3A, FIG. 3B, FIG. 3C, FIG. 4A, FIG. 4B, FIG. 5 and FIG. 6. However, the method 700 may also be carried out in any desired environment. Further, the aforementioned definitions may equally apply to the description below.

The method commences at step 702, generating two color-coded fiducial markers by the fiducial marker-encoding module. Thereafter at step 704, embedding the color-coded fiducial markers on the wagon. Thereafter at step 706, capturing the continuous image frames by the camera. Thereafter at step 708, detecting and localizing the color-coded fiducial markers of the wagon. Thereafter at step 710, recognizing the digits from the color-coded fiducial markers. Thereafter at step 712, forming the ten-digit wagon number by the digit-generating module. Thereafter at step 714, calculating the last check digit of the wagon. Thereafter at step 716, forming the eleven-digit wagon number by the digit-generating module.

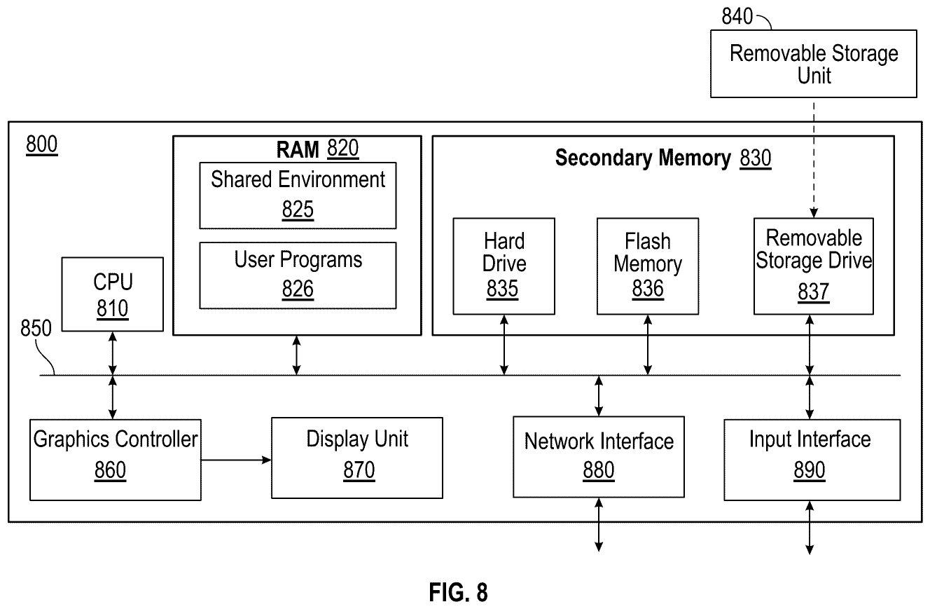

Referring to FIG. 8, FIG. 8 is a block diagram illustrating the details of digital processing system 800 in which various aspects of the present disclosure are operative by execution of appropriate software instructions. Digital processing system 800 may correspond to the first computing device 308 and the second computing device 310 (or any other system in which the various features disclosed above can be implemented).

Digital processing system 800 may contain one or more processors such as a central processing unit (CPU) 810, random access memory (RAM) 820, secondary memory 830, graphics controller 860, display unit 870, network interface 880, an input interface 890. All the components except display unit 870 may communicate with each other over communication path 850, which may contain several buses as is well known in the relevant arts. The components of FIG. 8 are described below in further detail.

CPU 810 may execute instructions stored in RAM 820 to provide several features of the present disclosure. CPU 810 may contain multiple processing units, with each processing unit potentially being designed for a specific task. Alternatively, CPU 810 may contain only a single general-purpose processing unit.

RAM 820 may receive instructions from secondary memory 830 using communication path 850. RAM 820 is shown currently containing software instructions, such as those used in threads and stacks, constituting shared environment 825 and/or user programs 826. Shared environment 825 includes operating systems, device drivers, virtual machines, etc., which provide a (common) run time environment for execution of user programs 826.

Graphics controller 860 generates display signals (e.g., in RGB format) to display unit 870 based on data/instructions received from CPU 810. Display unit 870 contains a display screen to display the images defined by the display signals. Input interface 890 may correspond to a keyboard and a pointing device (e.g., touch-pad, mouse) and may be used to provide inputs. Network interface 880 provides connectivity to a network (e.g., using Internet Protocol), and may be used to communicate with other systems (such as those shown in FIG. 3, a network 304) connected to the network 304.

Secondary memory 830 may contain hard drive 835, flash memory 836, and removable storage drive 837. Secondary memory 830 may store the data software instructions (e.g., for performing the actions noted above with respect to the Figures), which enable digital processing system 800 to provide several features in accordance with the present disclosure.

Some or all of the data and instructions may be provided on the removable storage unit 840, and the data and instructions may be read and provided by removable storage drive 837 to CPU 810. Floppy drive, magnetic tape drive, CD-ROM drive, DVD Drive, Flash memory, a removable memory chip (PCMCIA Card, EEPROM) are examples of such removable storage drive 837.

The removable storage unit 840 may be implemented using medium and storage format compatible with removable storage drive 837 such that removable storage drive 837 can read the data and instructions. Thus, removable storage unit 840 includes a computer readable (storage) medium having stored therein computer software and/or data. However, the computer (or machine, in general) readable medium can be in other forms (e.g., non-removable, random access, etc.).

In this document, the term “computer program product” is used to generally refer to the removable storage unit 840 or hard disk installed in hard drive 835. These computer program products are means for providing software to digital processing system 800. CPU 810 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 830. Volatile media includes dynamic memory, such as RAM 820. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 850. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Although the present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present disclosure is defined by the appended claims and includes both combinations and sub-combinations of the various features described hereinabove as well as variations and modifications thereof, which would occur to persons skilled in the art upon reading the foregoing description.

We claim:

1. A system for encoding and decoding color-coded fiducial markers, comprising:
a fiducial marker-encoding module configured to encode one or more digits using one or more color-coded fiducial markers and generate the one or more color-coded fiducial markers, the one or more color-coded fiducial markers embedded on an imaging subject placed in the field of view of a camera, the imaging subject comprising at least one of: boxed cargos; wagons; objects; goods; and vehicles;
the camera configured to identify motion of the imaging subject and configured to capture the imaging subject, the camera configured to transmit the one or more image frames to a first computing device and a second computing device over a network, the one or more image frames comprising one or more images of the color-coded fiducial markers, the first computing device and the second computing device comprising a fiducial marker-decoding module configured to receive one or more image frames from the camera, the fiducial marker-decoding module comprising a fiducial marker detection module, wherein the fiducial marker detection module configured to detect presence and location information along with color-coded fiducial markers information from the one or more image frames of the one or more color-coded fiducial markers using a visual object detection technique and machine vision technique, the fiducial marker detection module configured to transmit the presence and location information along with the color-coded fiducial markers information to a fiducial marker recognition module, the fiducial marker recognition module configured to detect the one or more color-coded fiducial markers from the one or more image frames and the one or more detected color-coded fiducial markers used to recognize one or more sub-makers positioned in the one or more color-coded fiducial markers;
a digit-generating module configured to decode the one or more digits and form a number from the one or more sub-makers positioned in the one or more color-coded fiducial markers; and
a digit-calculating module configured to calculate a last check digit from the one or more color-coded fiducial markers.

2. The system as claimed in claim 1, wherein the one or more color-coded fiducial markers information comprising a position information of the one or more color-coded fiducial markers.

3. The system as claimed in claim 1, wherein the one or more color-coded fiducial markers comprising a first sub-marker, a second sub-marker, a third-sub-marker, a fourth sub-marker, a fifth sub-marker, and a sixth sub-marker.

4. The system as claimed in claim 1, wherein the two sub-markers placed adjacent to each other used to represent a single digit (0, 1, 2, 3, 4, 5, 6, 7, 8, 9) of the decimal number system.

5. The system as claimed in claim 1, wherein the one or more sub-markers are represented in one or more colors.

6. The system as claimed in claim 5, wherein the one or more colors of the one or more sub-markers comprising a red color sub-marker, a black color sub-marker, a blue color sub-marker, a green color sub-marker, and a yellow color sub-marker.

7. The system as claimed in claim 1, wherein the one or more decoded digits from the one or more sub-makers positioned in the one or more color-coded fiducial markers comprising a manufacturing date of a product, a wagon number.

8. The system as claimed in claim 1, wherein the fiducial marker recognition module comprising an image processing technique configured to automatically detect each sub-marker and a color information.

9. The system as claimed in claim 1, wherein the fiducial marker recognition module configured to obtain the one or more digits after detecting the one or more sub-markers along with the recognition of color information.

10. The system as claimed in claim 1, wherein the fiducial marker-decoding module comprising a computer vision technology configured to detect one or more color-coded fiducial markers.

11. The system as claimed in claim 1, wherein the one color-coded fiducial marker comprising of at least six sub-markers in a grid-like fashion.

12. The system as claimed in claim 1, wherein the one or more color-coded fiducial markers are in the form of a matrix.

13. The system as claimed in claim 1, wherein the one or more color-coded fiducial markers are printed on an object in the field of view of the camera which appears in the one or more image frames produced, for use as a point of reference or a measure.

14. The system as claimed in claim 1, wherein the one or more color-coded fiducial markers are positioned into or on the imaging subject.

15. A method for encoding and decoding color-coded fiducial markers, comprising:
encoding one or more digits using one or more color-coded fiducial markers and generating the one or more color-coded fiducial markers by a fiducial marker-encoding module, the one or more color-coded fiducial markers embedded on an imaging subject in a field view of a camera;
identifying a motion of the imaging subject by the camera and capturing the imaging subject, the imaging subject comprising at least one of: boxed cargos; wagons; objects; goods; and vehicles;
transmitting the one or more image frames to a first computing device and a second computing device over a network, the one or more image frames comprising one or more images of the color-coded fiducial markers;
receiving one or more image frames by a fiducial marker-decoding module configured from the camera;
detecting presence and location information along with color-coded fiducial markers information from the one or more image frames of the one or more color-coded fiducial markers by a fiducial marker detection module;
transmitting the presence and location information along with the color-coded fiducial markers information from the fiducial marker detection module to a fiducial marker recognition module;
recognizing one or more sub-makers positioned in the one or more color-coded fiducial markers by the fiducial marker recognition module;
decoding the one or more digits to form a number from the one or more sub-makers positioned in the one or more color-coded fiducial markers by a digit-generating module; and
calculating a last check digit from the one or more color-coded fiducial markers by a digit-calculating module.
